(19) United States
(12) Patent Application Publication
(10) Pub. No.: US 2010/0038821 A1
(43) Pub. Date: Feb. 18, 2010

(54) Tactile Enhancement For Input Devices

(75) Inventors: Kurt A. Jenkins, Sammamish, WA (US); Jeffrey J. Heinz, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/193,049

(22) Filed: Aug. 18, 2008

(51) Int. Cl. B29C 59/02; B32B 7/10; G06F 3/033

(52) U.S. Cl. 264/293; 428/41.8; 345/161

(57) ABSTRACT

Embodiments related to the tactile enhancement of a computer input device are disclosed herein. In one disclosed embodiment, a method of making removable tactile-enhancing grips for a computer input device is disclosed. The method comprises heating a thermoplastic elastomeric sheet to a temperature at which the thermoplastic elastomeric sheet is capable of receiving and retaining an imprinted feature, pressing onto the thermoplastic elastomeric sheet a plate comprising a pattern, thereby embossing the pattern onto the thermoplastic elastomeric sheet, and cooling the thermoplastic elastomeric sheet to a temperature at which the pattern is retained in the thermoplastic elastomeric sheet. An adhesive layer is then formed on an opposite side of the thermoplastic elastomeric sheet as the pattern.

### BACKGROUND

Computer input devices, such as mice, gaming controls, etc., may be formed from two or more co-molded polymer materials. For example, some mice have an outer shell that comprises both a rigid, relatively smooth plastic material, and a softer elastomeric grip material disposed at locations on the shell that are in contact with a user's fingers or hand during normal use. However, co-molding processes that may be used to integrate the materials together may limit design freedom. Further, the materials may not be recyclable together, thereby impacting the recyclability of the device as a whole.

Another approach to facilitating a user's grip on a computer input device involves coating grip areas of a molded device with soft-touch paint or other such finish. However, the use of soft-touch paint also may limit recyclability due to incompatible recycling properties of the device and the soft-touch paint.

### SUMMARY

Accordingly, various embodiments related to the tactile enhancement of a computer input device are disclosed herein. For example, in one disclosed embodiment, a method of making removable tactile-enhancing grips for a computer input device comprises heating a thermoplastic elastomeric sheet to a temperature at which the thermoplastic elastomeric sheet is capable of receiving and retaining an imprinted feature, pressing onto the thermoplastic elastomeric sheet a plate comprising a pattern, thereby embossing the pattern onto the thermoplastic elastomeric sheet, cooling the thermoplastic elastomeric sheet to a temperature at which the pattern is retained in the thermoplastic elastomeric sheet, and forming an adhesive layer on an opposite side of the thermoplastic elastomeric sheet as the pattern.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an embodiment of a recyclable computer input device kit.

FIG. 2 shows an embodiment of a set of removable grip elements of the kit of FIG. 1.

FIG. 3 shows a magnified view of an embodiment of a pattern element formed in the set of removable grip elements of FIG. 2.

FIG. 4 shows a sectional view of the pattern element of FIG. 3.

FIG. 5 shows a sectional view of another embodiment of a pattern element.

FIG. 6 shows a process flow depicting an embodiment of a method for forming a tactile-enhancing set of removable grip elements.

### DETAILED DESCRIPTION

FIG. 1 shows an embodiment of a recyclable computer input device kit 100. Kit 100 comprises an input device 102, depicted as a mouse, and a tactile-enhancing set of removable grip elements 104. The set of removable grip elements 104 comprises a thin sheet of a textured, adhesive-backed thermoplastic elastomeric material, the texturing of which is described below. The set of removable grip elements 104 comprises one or more pre-cut grip elements 106 that may be peeled by a user from a backing sheet and adhered to the input device 102 in any desired location. In this manner, a location of each grip element 106 on the input device 102 may be selected by a user to suit the user's specific ergonomic desires. This is in contrast to an input device that comprises co-molded or soft-painted grips, which may not be movable to suit a specific user's hand shape and size. Several examples of grip element shapes are shown in FIG. 1, including square, circular, and oval shapes. However, it will be appreciated that a grip element may have any suitable shape to be mounted to any suitable input device. Further, while disclosed herein in the context of a computer mouse, it will be understood that other embodiments of a recyclable computer input device kit may alternatively/additionally comprise a keyboard, gaming control, or any other suitable input device.

The input device 102 and the set of grips elements 104 each may be formed from a recyclable material. Further, the set of grip elements 104 may comprise a removable adhesive backing that allows the grip elements 106 to be easily removed from the input device 102 if desired. In this manner, both the input device 102 and the grip elements 106 may be recycled by removing the grip elements 106 from the input device 102 prior to recycling. This is in contrast to an input device with co-molded or soft-painted grips, which may not be recyclable due to incompatible recycling properties of the different materials incorporated into the input device.

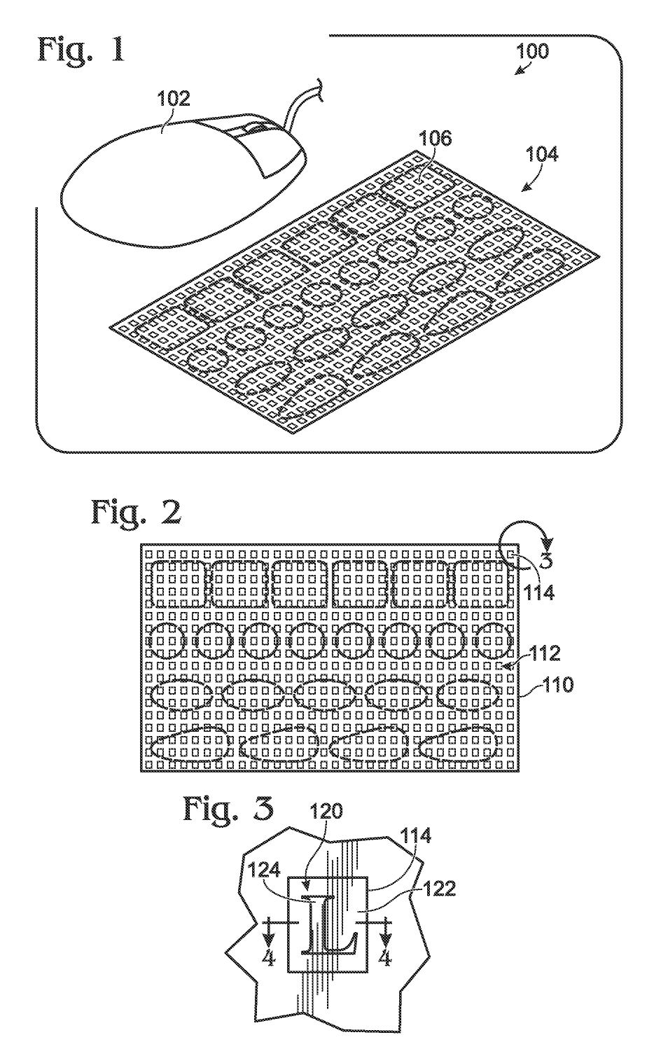

The thermoplastic elastomeric sheet from which the set of removable grip elements 104 is formed is embossed with a pattern that textures the surface of the thermoplastic elastomeric sheet. This may improve a grip of the material compared to an unembossed sheet of the material. Referring to FIG. 2, the thermoplastic elastomeric sheet is shown at 110, and an embossed pattern is shown at 112. The embossed pattern 112 comprises a plurality of individual pattern elements 114. In the depicted embodiment, the pattern elements 114 are of a sufficiently small size that each pre-cut grip element contains a plurality of pattern elements 114. However, in other embodiments, either larger or smaller pattern elements may be used. For example, in some embodiments, a single pattern element may extend over the entire thermoplastic elastomeric sheet 110. In other embodiments, each pre-cut grip element 106 may comprise a pattern specifically designed fit within, enhance, decorate, and/or complement a specific shape of the pre-cut grip element.

In some embodiments, each individual pattern element 114 may have the shape of a logo, trademark, or other such indicia. For example, the pattern elements 114 may each take the form of the logo of a company selling the recyclable computer device kit 100. FIGS. 3-4 show one example of a suitable pattern element 114 in the form of a generic L-shaped logo 120. Logo 120 comprises a background region 122 and an L-shaped indicia 124 formed in the background region 122. FIG. 4 also shows an embodiment of a plate 125 that may be used to emboss the logo 120.

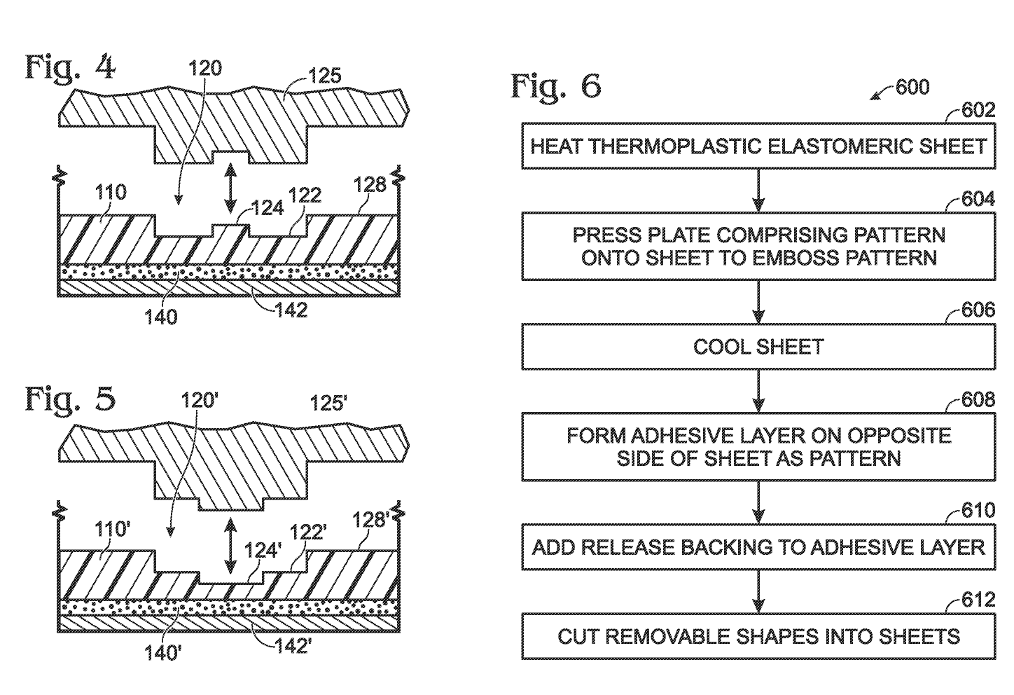

As shown in FIG. 4, the L-shaped indicia 124 may protrude toward the surface 128 adjacent to the logo compared the background region 122. Referring next to FIG. 5, which shows an alternate embodiment of a logo at 120′ formed in a thermoplastic polymer sheet 110′, and also a plate for embossing the logo at 125′, the L-shaped indicia, indicated at 124′ may alternatively be recessed relative to the background region, indicated at 122′. In yet other embodiments, both the background region and the indicia of a logo may protrude from a surrounding surface. Such a structure may be formed by embossing the regions around the logo more than the features in the logo. In any case, FIGS. 4-5 illustrate that individual pattern elements may have features with two or more different non-zero heights/depths relative to the surface adjacent to the pattern element.

Depending upon the thermoplastic material and molding/embossing processed used, intricate, detailed features may be formed, and may thereby allow the clear representation of complex logo designs at small sizes. An embossing plate for creating such detailed features may be formed in any suitable manner. For example, a plate may be formed by utilizing lithographic electroplating to form a desired pattern. Such a process may be performed as follows. First, a layer of a resist material may be deposited and then patterned on a smooth metal plate. Next, a layer of metal may be electroplated over the entire surface of the metal plate. Then the resist layer is removed, thereby removing any metal over the resist and leaving behind a pattern on the plate. Multiple resist patterning/electroplating/resist removal cycles may be used to form plates having more complex patterns. Embodiments of methods for embossing the thermoplastic elastomeric sheet are described in more detail below.

FIGS. 4 and 5 also illustrate an adhesive layer, respectively at 140 and 140′, and a release layer, respectively at 142 and 142′. As mentioned above, the adhesive layer may comprise an adhesive that is easily removable from the input device. In this manner, any grip elements located on the device may simply be peeled off of the device at end-of-life to allow recycling of both the input device and the grip elements. Any suitable adhesive may be used. Suitable adhesives include, but are not limited to, adhesives that adhere securely to the material from which an input device is made, that can be peeled off of or otherwise removed from, the input device, and/or that do not negatively impact the recyclability of the input device or grip element.

The thermoplastic elastomeric sheet 110 may have any suitable thickness. For example, in some embodiments, the sheet may be sufficiently thin not to alter the ergonomic “feel” of the input device from a finger positioning standpoint. For example, a thick neoprene pad may cause a user's fingers to be positioned in a noticeably different position, which may negatively impact a user experience. In contrast, the use of a relatively thinner material may provide a more familiar feel for the input device during use. Examples of suitable thicknesses include, but are not limited to, between 0.005″ and 0.02″. In specific embodiments, the thickness may be 0.005″, 0.008″, 0.010″, 0.012″, 0.015″, and 0.020″.

Likewise, any suitable thermoplastic elastomeric material may be used for the thermoplastic elastomeric sheet 110. Examples include, but are not limited to, TPUR (thermoplastic polyurethane), TPO (thermoplastic olefin), TPR (thermoplastic rubber), SBR (styrene-butadiene rubber), and PVC (polyvinyl chloride). Material selection may depend upon various factors such as hardness, appearance, etc. For example, in some embodiments, softer thermoplastic elastomeric polymers may be used to give an increased feel of grip compared to harder materials. Examples of suitable durometers for the thermoplastic elastomeric sheet 110 include, but are not limited to, durometers in a range of 25 A to 80 A. The use of a thin patterned sheet of a softer material may impart a “grippier” feel relative to a harder material. Likewise, in some embodiments, transparent thermoplastic elastomeric materials may be used to reduce the visual presence of a grip element 106 on the input device 102. In other embodiments, one or more colorants may be added to the material from which the thermoplastic elastomeric sheet 110 is formed.

FIG. 6 shows an embodiment of a method 600 for forming an embossed thermoplastic elastomeric sheet. Method 600 comprises, at 602, heating an unembossed thermoplastic elastomeric sheet to a temperature at which it is capable of receiving and retaining an imprinted feature. Next, at 604, a pre-configured plate is pressed onto the thermoplastic elastomeric sheet to emboss a pattern on the sheet. The term “plate” as herein may include flat plates, cylindrical plates, or plates of any other suitable shape. Then, at 606, the thermoplastic elastomeric sheet is cooled to retain the pattern in the sheet. Once the pattern is embossed onto the sheet, an adhesive layer and a releaseable backing sheet are applied, at 608 and 610 respectively, to an opposite of the thermoplastic elastomeric sheet as the pattern, and then desired shapes for grip elements are cut into the sheet. The pre-cut shapes may correspond to shapes of keyboard keys, mouse buttons, a mouse body, gaming controls grips, or any other desired input device grip surface.

By following method 600, a set of removable grip elements embossed with a repeating pattern comprising a logo, trademark, or other indicia may be formed in a soft, thin elastomeric sheet. The combination of the texture imparted by the pattern and the softness of the sheet may give the material a grippy feel that helps to reduce user fatigue. Further, the use of a logo, trademark, or the like may add advertising value to the grip elements. The removable nature of the grips may allow a user to place the grips at a location most suited to that user, as opposed to co-molded integrated grips that cannot be repositioned. Additionally, the removable nature of the grip elements may allow the grip elements to be used with devices made of materials that are otherwise incompatible with the thermoplastic elastomeric grip element material from a recycling standpoint, as the grip elements may be removed prior to recycling. Additionally, the use of an embossing process may allow a grip-enhancing pattern to be formed in a thinner thermoplastic elastomeric sheet of material than with injection molding or other such processes.

It will be appreciated that the configurations and/or approaches described herein are exemplary in nature, and that these specific embodiments or examples are not to be considered in a limiting sense, because numerous variations are possible. It will also be understood the order of any of the above-described processes is not necessarily required to achieve the features and/or results of the embodiments described herein, but is provided for ease of illustration and description. The subject matter of the present disclosure includes all novel and nonobvious combinations and subcombinations of the various processes, systems and configurations, and other features, functions, acts, and/or properties disclosed herein, as well as any and all equivalents thereof

1. A method of making removable tactile-enhancing grips for a computer input device, comprising:
heating a thermoplastic elastomeric sheet to a temperature at which the thermoplastic elastomeric sheet is capable of receiving and retaining an imprinted feature;
pressing onto the thermoplastic elastomeric sheet a plate comprising a pattern, thereby embossing the pattern onto the thermoplastic elastomeric sheet;
cooling the thermoplastic elastomeric sheet to a temperature at which the pattern is retained in the thermoplastic elastomeric sheet; and
forming an adhesive layer on an opposite side of the thermoplastic elastomeric sheet as the pattern.

2. The method of claim 1, wherein embossing the pattern comprises embossing a repeating pattern element.

3. The method of claim 1, wherein embossing the pattern comprises embossing a repeating logo.

4. The method of claim 1, wherein the thermoplastic elastomeric sheet comprises one or more of TPUR (thermoplastic polyurethane), TPO (thermoplastic olefin), TPR (thermoplastic rubber), SBR (styrene-butadiene rubber), and PVC (polyvinyl chloride)

5. The method of claim 1, wherein embossing the pattern comprises embossing a pattern element that comprises features having two or more non-zero heights and/or depths relative to a surface of the thermoplastic elastomeric sheet.

6. The method of claim 1, wherein the thermoplastic elastomeric sheet comprises a durometer within a range of 25-80 A.

7. The method of claim 1, wherein the thermoplastic elastomeric sheet comprises a thickness in a range of 0.005″-0.020″.

8. The method of claim 1, wherein the thermoplastic elastomeric sheet is transparent.

9. The method of claim 1, further comprising cutting one or more grip elements into the thermoplastic elastomeric sheet.

10. A tactile-enhancing set of grip elements, comprising:
a thermoplastic elastomeric sheet comprising an embossed pattern formed thereon, the embossed pattern comprising a repeating pattern element;
an adhesive layer disposed on an opposite side of the thermoplastic elastomeric sheet as the embossed pattern;
a release layer disposed over the adhesive layer; and
one or more pre-cut grip elements formed in the thermoplastic elastomeric sheet, the pre-cut grip elements being configured to fit a corresponding tactile control on a computer input device.

11. The tactile-enhancing grip kit of claim 10, wherein the pattern element comprises a logo.

12. The tactile-enhancing grip kit of claim 10, wherein the thermoplastic elastomeric sheet has a durometer in a range of 25-80 A.

13. The tactile-enhancing grip kit of claim 10, wherein the thermoplastic elastomeric sheet comprises one or more of TPUR (thermoplastic polyurethane), TPO (thermoplastic olefin), TPR (thermoplastic rubber), SBR (styrene-butadiene rubber), and PVC (polyvinyl chloride).

14. The tactile-enhancing grip kit of claim 10, wherein the thermoplastic elastomeric sheet has a thickness in a range of 0.005″-0.020″.

15. The tactile-enhancing grip kit of claim 10, wherein the thermoplastic elastomeric sheet is transparent.

16. The tactile-enhancing grip kit of claim 10, wherein the pattern element has a plurality of features having different non-zero depths relative to a surface of the thermoplastic elastomeric sheet.

17. The tactile-enhancing grip kit of claim 10, wherein the adhesive is a removable adhesive.

18. A recyclable computer input device kit, comprising:
a computer input device formed from a recyclable material;
a thermoplastic elastomeric sheet comprising an embossed pattern formed thereon, the embossed pattern comprising a pattern element having two or more non-zero depths relative to a surface of the thermoplastic elastomeric sheet;
a plurality of pre-cut grip elements formed in the thermoplastic elastomeric sheet and configured to be mounted to locations on the input device having shapes corresponding to the pre-cut grip elements, wherein each of the plurality of pre-cut grip elements contains a plurality of pattern elements; and
an adhesive layer and release sheet disposed on an opposite side of the thermoplastic elastomeric sheet as the embossed pattern.

19. The kit of claim 18, wherein the input device comprises one or more of a keyboard, a mouse, and a gaming control.

20. The kit of claim 18, wherein the thermoplastic elastomeric sheet comprises one or more of TPUR (thermoplastic polyurethane), TPO (thermoplastic olefin), TPR (thermoplastic rubber), SBR (styrene-butadiene rubber), and PVC (polyvinyl chloride).
